(19) United States
(12) Patent Application Publication
(10) Pub. No.: US 2010/0192297 A1
(43) Pub. Date: Aug. 5, 2010

(54) HANDLING SYSTEM FOR LIFTING OR MOVING A PERSON, A METHOD FOR LIFTING OR MOVING A PERSON AND USE HEREOF

(75) Inventors: Asger Gramkow, Augustenborg (DK); Steffen Sundbaek, Augustenborg (DK)

Correspondence Address: CANTOR COLBURN, LLP, 20 Church Street, 22nd Floor, Hartford, CT, 06103, US

(73) Assignee: HECARE SYSTEMS APS, SONDERBORG (DK)

(21) Appl. No.: 12/680,138

(22) PCT Filed: Sep. 3, 2008
(86) PCT No.: PCT/DK08/00316

§ 371 Date: Mar. 25, 2010

(30) Foreign Application Priority Data
Sep. 28, 2007 (DK) PA 2007 01405

(51) Int. Cl. A61G 7/10

(52) U.S. Cl. 5/87.1

(57) ABSTRACT

A handling system for lifting or moving a person from a first position to another, including a bottom part having a substantially vertical guiding part, and a guided part being guided by the vertical guiding part allowing a lifting arm to be at least vertically adjustable, the system further including a support part for fixating and supporting the person during the lifting or moving, and a support connection connected to drive means, for winding or unwinding the support connection, and the support part during the lifting or moving, where the at least vertically adjustable lifting arm is actuated by actuator means during the at least vertical adjusting of the lifting arm.

### TECHNICAL FIELD

The disclosure relates to a handling system for lifting or moving a person from a first position to another, a method for lifting or moving a person and use hereof.

### BACKGROUND

Handling systems for lifting and moving persons and particularly disabled persons are well known in the art.

A typical handling system comprises a base part provided with wheels supporting a tower part with a horizontal arm at the top. The free end of the horizontal arm is connected to a device such as a harness or a chair supporting and fixating the person during the lifting and moving from e.g. a bed to a chair.

Some of the known handling systems are also provided with a guided connection between the tower and the horizontal arm, making it possible to manually adjust the height of the horizontal arm with an electric linear actuator and thus handle the person.

U.S. Pat. No. 5,758,371 concerns a handling device for disabled patients, which can be adjusted in different directions by means of a plurality of actuators. The handling system comprises the possibility of vertical adjustment of a lifting arm, by use of an actuator.

A problem with this solution is that the actuator has to overcome the weight of the disabled patient, as well as the weight of the lifting arm and the frictions concerning vertical adjustment of the lifting arm, i.e. considerable requirements to the actuator.

A further problem with the solution in the US patent is, that a vertically adjustment of the horizontal arm by means of the actuator, simultaneous results in an often undesirable displacement of the harness carrying the disabled person.

The disclosure seeks to provide a handling system and method, without the above mentioned disadvantages.

Especially, the disclosure seeks to create a handling system which is simple to operate and reliable in use.

### BRIEF SUMMARY

The invention relates to a handling system wherein said at least vertically adjustable lifting arm is actuated by actuator means during said at least vertical adjusting of the lifting arm.

Hereby is achieved a handling system which is simple to operate and reliable in use and especially in relation to the vertical adjustment of the lifting arm.

It is especially advantageous to carry out the vertical adjustments of the lifting arm by means of the actuator, since the drive means for winding and unwinding the support connection are carrying the load of the person. The actuator hereby only has to overcome the weight of the lifting arm comprising the vertical guided part, and frictions in guiding means relating to vertically adjusting of said lifting arm, in order to vertically adjust the lifting arm. Further the actuator only has to carry the weight of the lifting arm, to keep the lifting arm in a fixed position, when said actuator means are not carrying out the vertical adjusting.

In an aspect of the invention, the lifting arm is being maintained in a fixed position by the actuator means, when not being vertically adjusted. Hereby is achieved that the vertical adjustments of the lifting arm does not involve any manual actions by the operator beyond activating the electrical actuator on a control panel.

In an aspect of the invention, said actuator means comprises at least one electrical motor and at least one spindle e.g. with a thread comprising a rate of increase in the interval 1° to 30° and preferable in the interval 5° to 15°. Hereby is achieved an advantageous embodiment of the invention. Hereby is achieved that the spindle is not rotated without influence of e.g. an electrical motor, and the rate of increase hereby comprises a holding feature.

In an aspect of the invention, the electrical motor comprises a locking mechanism which is activated when the spindle is not rotated by the electrical motor. Hereby is achieved that the spindle is kept in a fixed position without the needs of electrical energy, which improves the safety of the system.

In an aspect of the invention, said actuator comprises a motor driven belt, a hydraulic actuator, a pneumatic actuator or linear actuating means including a chain or similar actuating solutions. Hereby are achieved advantageous features of the said actuator means, known to a person skilled in the art.

In an aspect of the invention, the adjusting of the vertical guided part is guided by at least two vertical adjustment guides preferably positioned opposite each other in relation to said guided part e.g. as pulleys and/or rollers. Hereby it is achieved a slight friction between the guided part and the guiding part, which minimises the need of force to vertical displacing the vertical guided part. Further a gliding movement of the guided part is enhanced.

In an aspect of the invention, the handling system comprises integrated or external control panels controllable by an operator, for at least controlling the actuator means. Hereby is achieved advantageous and easy control of the actuator means.

In an aspect of the invention, the support part is a walking harness for the patient. Hereby is achieved the possibility of supporting a walking person.

In an aspect of the invention, the system comprises a number of support connection guides for guiding the support connection inside the different parts of the system such as guides inside the lifting arm, inside the bottom part and/or said vertical guiding part. Hereby is achieved an advantageous guiding of the support connection, reducing friction in the system and facilitating an advantageous force distribution in the system.

The invention furthermore relates to a handling system for supporting a person in an upright position, said system comprising at least one control panel comprising control means for controlling at least one control function of the handling system, wherein said at least one control panel is positioned within reach of the person) when supported in the handling system. Hereby is achieved a firsthand influence of the handling system by the supported person.

In an aspect of the invention, said at least one control panel is positioned on the handling system e.g. on a supporting rod for supporting the person being handled by the handling system or connected via wired or wireless connection means to the handling system. Hereby an advantageous possibility of controlling at least one control function is achieved.

The invention also relates to a method for lifting or moving a person from a first position to another by a handling system preferably according to any of the preceding claims, said method comprising the steps of
positioning a person in a support part with a support connection,
activating drive means, for winding and unwinding the support connection via drive means, hereby vertically adjusting the support part, and
vertically adjusting said lifting arm of the handling system by means of an actuator, said actuator allowing the lifting arm to be vertically adjustable.

In an aspect of the invention a method is disclosed, where the handling system is fitted to support a person in an upright position e.g. in a walking situation by means of the support part, where said supported person is able to reach and control at least one control panel with means for controlling at least one control function of the handling system.

The invention further relates to a use of a handling system according to any of claims 1 to 9 and/or method according to claim 10 allowing a patient to walk when suspended in a support part of the handling system.

### BRIEF DESCRIPTION OF THE FIGURES

The invention will be described in the following with reference to the figures in which

FIG. 1 illustrates a handling system with a person hanging in a support part such as a handling chair,

FIG. 2 illustrates a close-up of the handling system,

FIG. 3 illustrates an embodiment of the vertical adjustment system,

FIG. 4 illustrates the bottom of the vertical guiding part of the bottom part, with the actuator comprising an electrical motor and a spindle,

FIG. 5 illustrates a close up of a part of the actuator comprising a spindle and a casing,

FIG. 6 illustrates the lowest part of the vertical guided part, seen from the side,

FIG. 7 illustrates the lowest part of the vertical guided part and the vertical guiding part, seen from the end

FIG. 8 illustrates the handling system with a person supported by the handling system, and an illustration of vertical adjustment of the vertical guided part,

FIG. 9 illustrates the handling system with vertical adjustment of the support part, and

FIG. 10 illustrates an embodiment of the invention, where the handling system is supporting a walking person.

### DETAILED DESCRIPTION

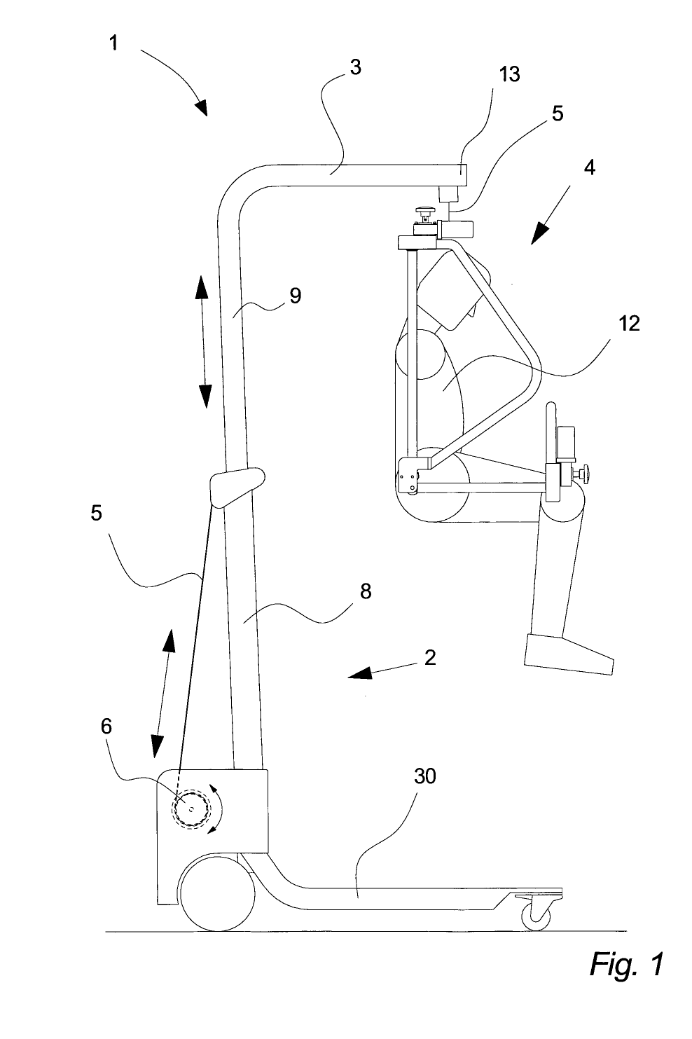

FIG. 1 illustrates a handling system 1 with a person 12 hanging in a support part 4 such as a handling chair. A support connection 5 connects the support part 4 with the free end of lifting arm 13 in the handling system 1.

The handling system 1 comprises a bottom part 2 comprising a horizontal bottom support part 30, a cover part 31, and vertical guiding part 8, where the vertical guiding part 8 is supporting a guided vertical part 9 of the lifting arm 3.

The drive means 6 winds and unwinds the support connection 5, and is hereby lifting or lowering the support part 4 with the person 12. The drive means 6 and the support connection 5 is hereby carrying the weight of the person 12 when the person is lifted or lowered, as well as when the person is held in a fixed position.

In an embodiment of the invention, the drive means 6 for winding and unwinding said support connection 5, is driven by an electrical motor which in a further embodiment of the invention comprises gearing means.

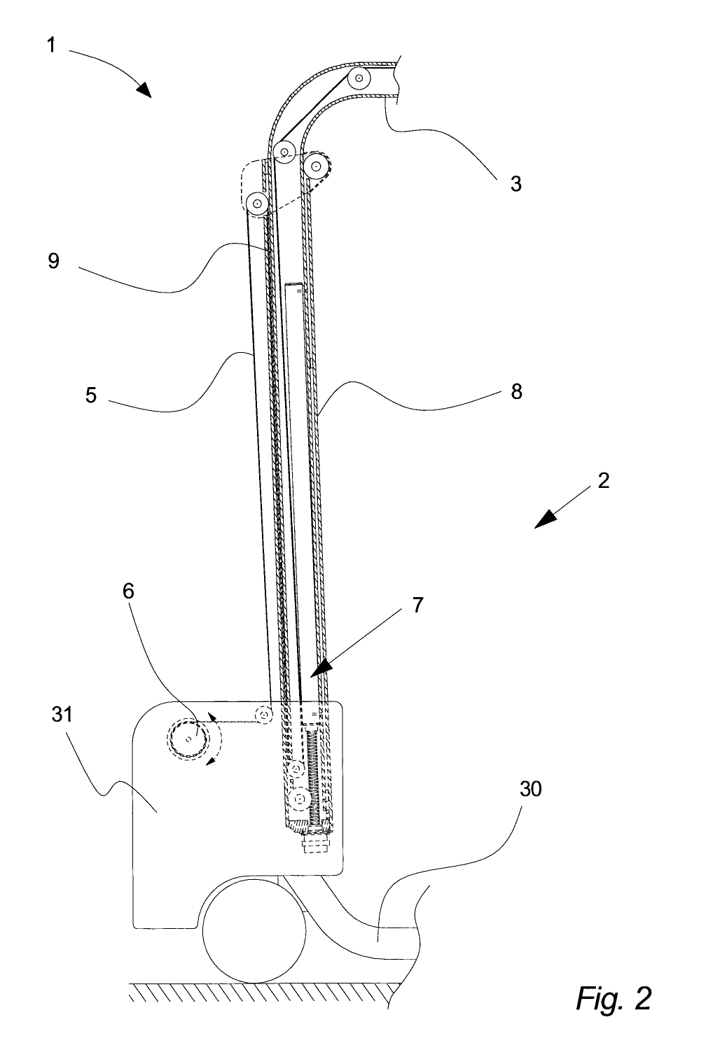

FIG. 2 illustrates a close-up of the handling system 1, with the cover part 31 covering the drive means 6, motors, gearings, batteries, a part of the vertical supporting part 8 and the like.

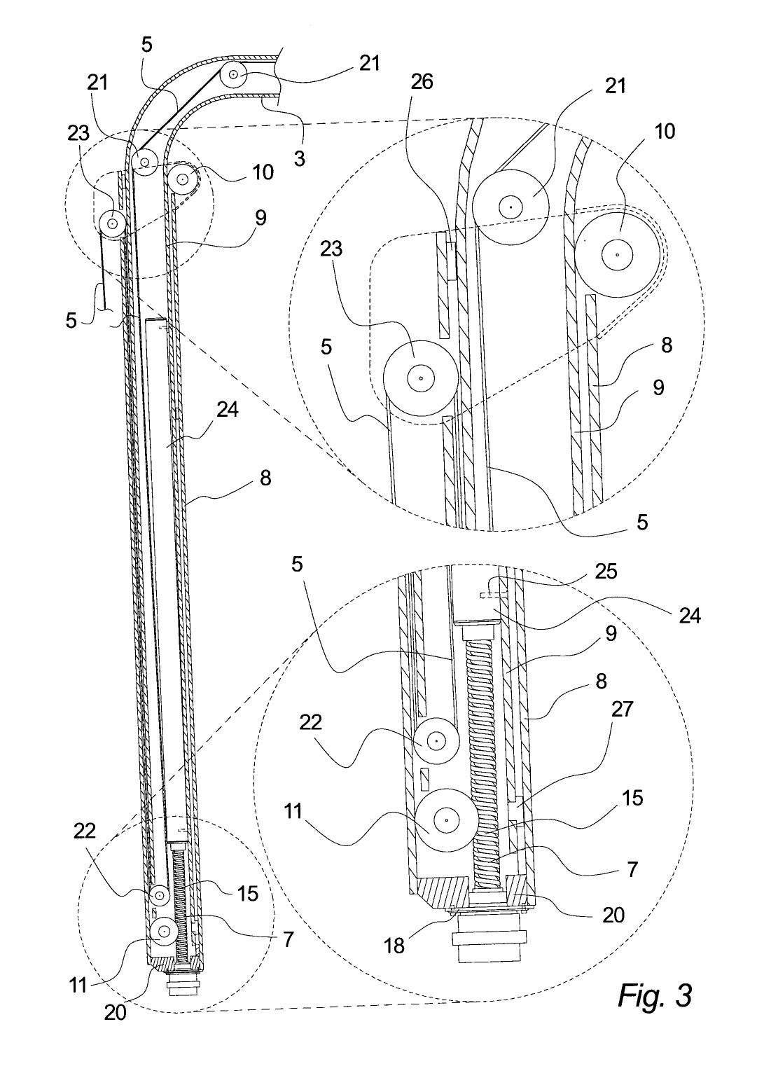

FIG. 3 illustrates the vertical guided part 9 of the lifting arm 3, inside the vertical guiding part 8 of the bottom part 2. The vertical guided part 9 comprises at least one corner support connection guide 21 placed substantially in the corner section between the horizontal part of the lifting arm 3 and the vertical guided part 9. The vertical guided part 9 further comprises a bottom support connection guide 22, placed at the lower part of the vertical guided part 9.

The support connection guides 21 and 22, together with a front support connection guide (not shown) placed at the free end of the lifting arm 3, and the support connection guide 23 fixated at the vertical guiding part 8, facilitates the guiding of the support connection during winding and unwinding of the support connection 5 by means of the drive means 6 (not shown in this figure). The said support connection guides as well guides the support connection when the horizontal arm 3 is kept in a fixed position by the drive means 6.

In a preferred embodiment of the invention, the support connection guides 21 and 22 are idling pulleys.

In a preferred embodiment of the invention, said support connection 5 is a belt.

In an embodiment of the invention the support connection 5 could be a chain. In this specific embodiment of the invention, at least one of the support connection guides is a chain wheel.

The displacement between the vertical guiding part 8 and the vertical guided part 9 is carried out by the actuator means 7, which in one embodiment comprises a motor 14 (not shown in FIG. 3) and a spindle 15 screwable connected in the nut 16 which is fixed to the casing 24. The nut 16 is in this embodiment of the invention a member of the casing 24, and is fixed at the end of the casing 24, said casing being fixed on the inside of the vertical guided part 9 by at least one bolt 25, welding, or the like. In another embodiment of the invention the nut 16 could be fixed inside the casing 24.

The upper vertical adjustment guide 10 is rotatable connected at the vertical guiding part 8, and the lower vertical adjustment guide 11 is rotatable connected at the inside of the vertical guided part 9. When the actuator means 7 is vertically displacing the vertical guided part 9 from the vertical guiding part 8, the adjustment guides 10 and 11 are facilitating a rolling movement between the vertical guided part 9 and the vertical guiding part 8.

In a preferred embodiment of the invention, said vertical adjustment guides are idling pulleys or rollers.

By the term “vertical adjustment guide” or “support connection guide” may be understood any kind of rod, pipe, pulley, wheel, roller, chain wheel, toothed wheel, timing wheel or other contraptions suitable for guiding a rolling movement.

It is noted that the vertical guiding part 8 and/or the vertical guided part 9 could comprise multiple vertical adjustment guides facilitating a rolling or gliding movement between the vertical parts 8 and 9.

In an embodiment of the invention at least one of the vertical adjustment guides 10 or 11 are a toothed wheel actuated by actuator means. The toothed wheel in this embodiment are interacting with tooth's placed at the vertical guided part 9 and/or on the vertical guiding part 8 (not shown), and when at least one of the wheels are actuated by said actuator means it causes a vertical displacement of the lifting arm 3. When the toothed wheels are not actuated by said actuator means, they keep the lifting arm in a fixed position.

The upper spacer 26 is fixed on the upper inner side of the vertical guiding part 8, while the lower spacer 27 is fixed on the lower outer side of the vertical guided part 9. When the actuator means 7 are vertically displacing the vertical guided part 9, the spacers 26 and 27 keeps a spacing between the vertical guided part 9 and the guiding part 8, and at the same time said spacers facilitates a gliding movement between the vertical guided part 9 and the vertical guiding part 8.

The spacers is in one embodiment of the invention made of Teflon, but may also be made of any other material or composition suitable for making a spacing between two surfaces, and at the same facilitate a gliding movement between said surfaces. Said spacers could in an aspect of the invention also be rollers, bars, or other contraptions suitable for guiding a rolling and/or gliding movement.

Both the vertical guiding part 8 and the vertical guided part 9 can comprise multiple spacers at more than one side of the parts 8 and 9, facilitating a stabilizing effect, spacing between the vertical parts 8 and 9, and a gliding or rolling connection between the vertical guiding part 8 and the vertical guided part 9.

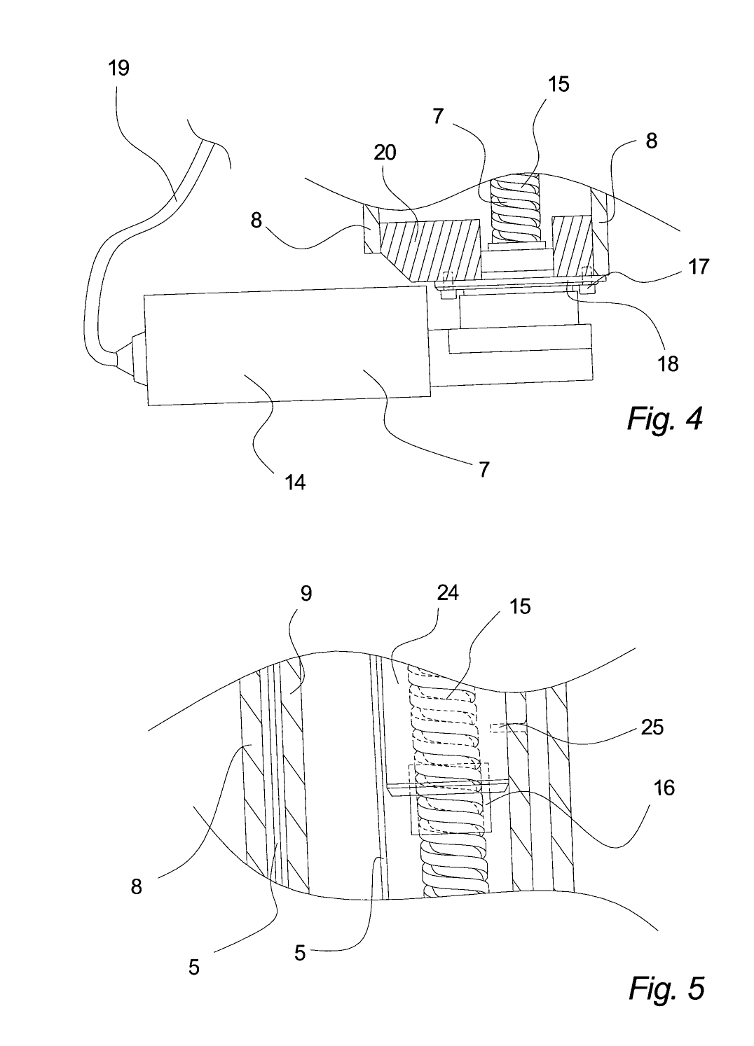

FIG. 4 illustrates the lower part of the vertical guiding part 8. The actuator means 7 for vertically adjustment of the lifting arm 3 in this case comprises an electrical motor 14, which is rotatable connected to the spindle 15, where the spindle comprises at least one thread around its longitudinal axis. The spindle 15 is rotatable connected to at least one mounting 18. The at least one mounting 18 is fixed by means of at least one bolt 17, to the actuator mounting 20 which is fixed to the bottom of the vertical guiding part 8. Said fixations could be accomplished by bolts, welding or another kind of fixation known to a person skilled in the art. The motor 14 is connected to the lower end of the spindle 15, so that the motor facilitates rotation of the spindle 15 along its longitudinal axis.

The spindle 15 could be a single- or double threaded spindle, as well as a multi threaded spindle.

The spindle 15 is at its upper end rotatable connected to a nut 16 (not shown in FIG. 2) which is secured to the vertical guided part 9. When the spindle is rotated around its longitudinal axis by the motor 14, it will hereby result in a vertical displacement between the vertical guiding part 8 and the vertical guided part 9. Depending on the direction of rotation of the spindle 15, the lifting arm 3 is hereby raised or lowered, caused by the screwing interaction between the spindle 15 and the nut 16.

When the motor 14 is not rotating the spindle 15 around its longitudinal axis, the guided vertical part 9 and hereby the lifting arm 3 is kept in a fixed position.

In one embodiment of the invention, the rate of increase of the thread on the spindle causes a friction between the nut 16 and the spindle 15 of an amount, where the weight of the lifting arm 3 does not cause a screwing movement between the nut 16 and the spindle, when the spindle is not actuated by the motor 14. Hereby a fixation of the lifting arm 3 is achieved, when the spindle 15 is not actuated.

In another embodiment of the invention the motor 14 comprises a locking mechanism when it is not actuated. The spindle 15 and hereby the lifting arm 3 is then kept in a fixed position when the motor is not actuated.

In a further embodiment of the invention the fixation of the spindle 15 when it is not actuated, is done partly by the friction between the nut 16 and the spindle 15, and a locking mechanism in the motor.

The connection between the motor 14 and the spindle 15 could in one embodiment of the invention comprise toothed wheels, which in a further embodiment could comprise gearing means.

The connection between the motor 14 and the spindle 15 could as well be accomplished by a belt, chain and chain wheels or any other suitable connections, which in a further embodiment of the invention could comprise a gearing.

The rotation of the spindle 15 by the motor 14 is controlled by control signals. The control signals could be wireless signals as well as control signals supplied by a chord 19.

The actuator means 7 could in an embodiment of the invention be a motor driven belt or a chain, as well as hydraulic or pneumatic means, or any similar actuators.

In an embodiment of the invention the actuator means 7 is controlled by an operator of the handling system 1.

In another embodiment of the invention the actuator means 7 is controlled by an external control unit (not shown). An example is a control unit which sends signals to the motor 14 when the handling system 1 gets near a door, hereby automatically securing that the lifting arm 3 is not too high to pass the doorframe. In this embodiment an operator still can control the actuator means 7 even if the actuator facilitates external control from an external control unit.

FIG. 5 illustrates a close up of the spindle 15, rotatable connected to the nut 6, which is fixed to the casing 15. When said spindle is rotated along its longitudinal axis, it is screwed through the nut 16, and is thereby screwing the spindle 15 in or out of the casing 24 which is fixed to the vertical guided part 9.

In an embodiment of the invention the nut 16 is directly fixed to the vertical guided part 9.

In an embodiment of the invention the spindle is rotatable connected to at least one bearing or the like (not shown in the drawings), which is fixed to the inner side of the vertical guided part 9. The bearing hereby stabilises the spindle, and prevents deformation of said spindle.

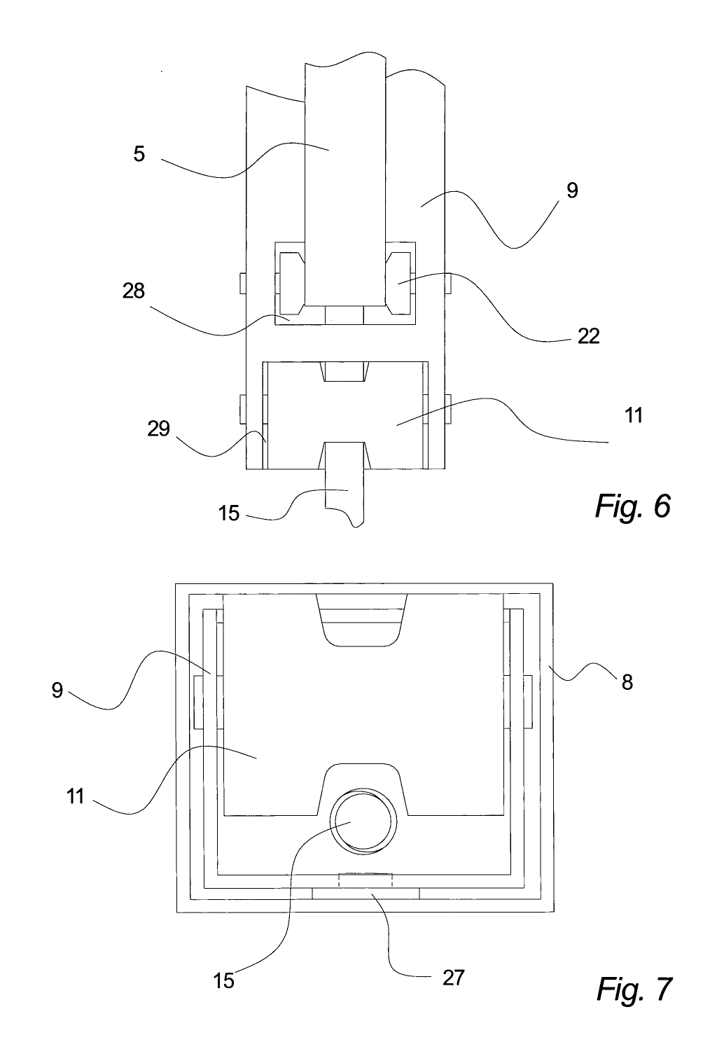

FIG. 6 illustrates the lowest part of the vertical guided part, seen from the back, with the support connection 5 guided by the bottom support connection guide 22. The support connection 5 is lead through the lead-in 28 for said support connection.

The lower vertical adjustment guide 11 is rotatable connected to the vertical guided part 9, and achieves a rolling connection with the vertical guiding part 8 through a hole or milling 29 at the lowest end of said vertical guided part 9.

FIG. 7 illustrates a part of the lowest end of the vertical guiding part 8 and the vertical guided part 9, seen from the lowest end of said vertical parts. The guided part 9 is placed inside the guiding part 8. As it is seen in FIG. 6 the lower vertical adjustment guide 11 obtains a rolling connection to at least one inner side of the vertical guiding part 8, and is at the same time facilitating a spacing between the parts 8 and 9. At the other side the lower spacer 27 is keeping a space between the guided part 9 and the guiding part 8, and is at the same time facilitating a gliding movement between said parts 8 and 9.

In an embodiment of the invention the guiding vertical part is placed inside the guided vertical part.

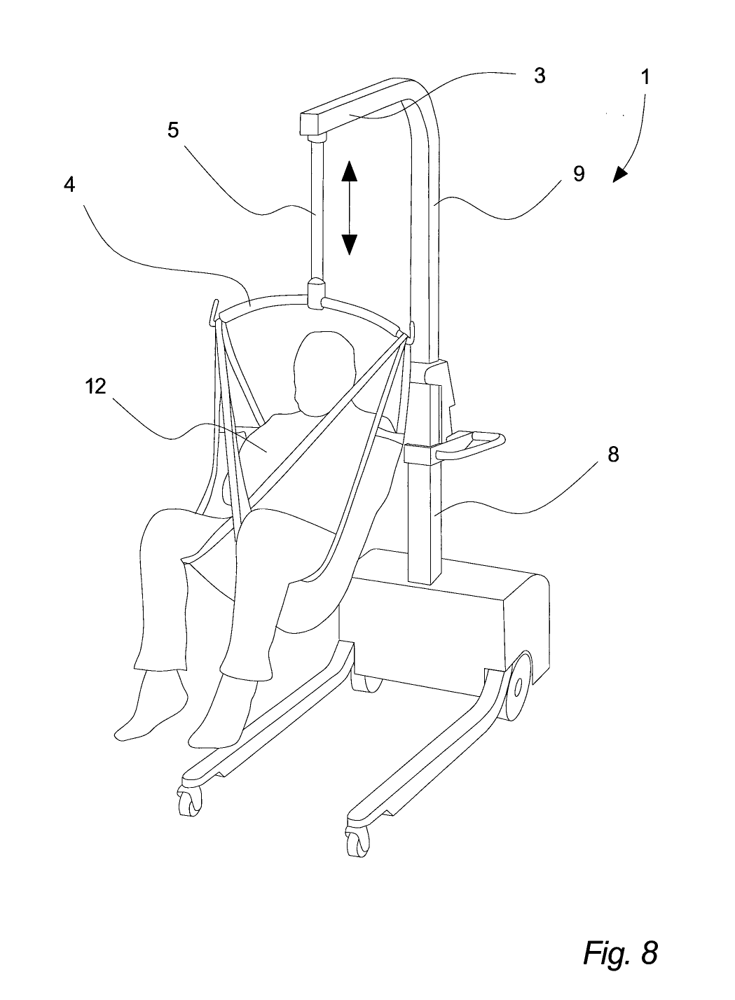

FIG. 8 illustrates the handling system with vertical adjustment of the support part 4. This adjustment can be performed independently of the vertical adjustment of the vertical guided part 9.

The vertical adjustment of the support part 4 is performed by winding or unwinding the support connection 5. The actuator means 7 (not shown in FIG. 8) are not used for vertical adjustment of the support part 4. The weight of the person 12 as well as the weight of the support part 4 is carried by the support connection 5.

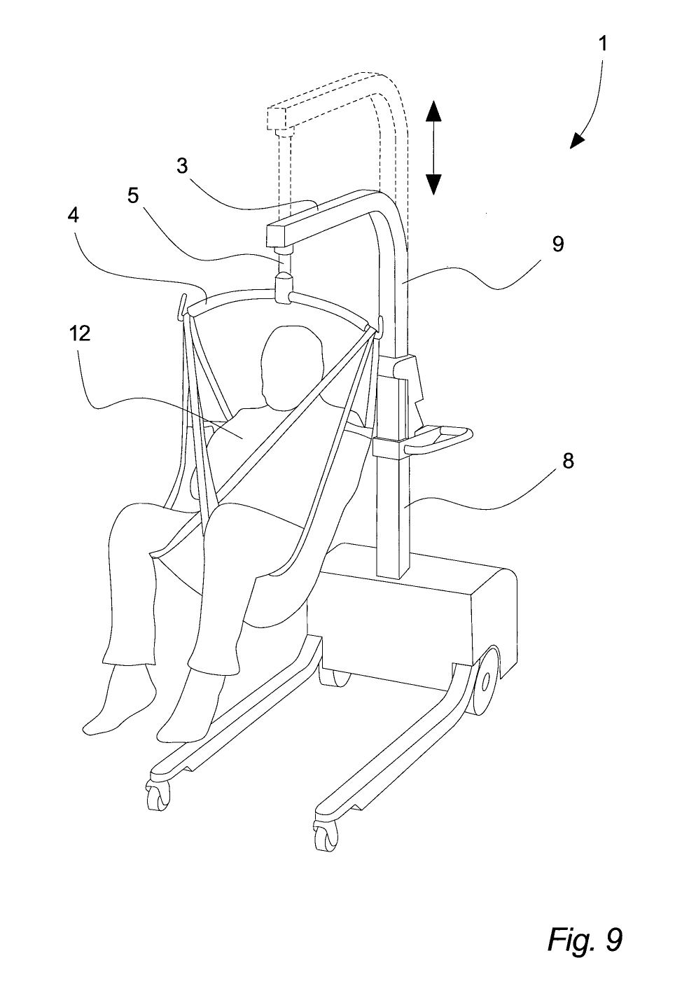

FIG. 9 illustrates an embodiment of the invention with vertical adjustment of the vertical guided part 9. The vertical adjustment of the guided part 9 does not vertically adjust the support part 4. The vertical adjustment of the vertical guided part 9 can be performed independent of the vertical adjustment of the support part 4.

The vertical adjustment of the vertical guided part 9 is performed by activating the actuator means 7 (not shown in FIG. 9). This causes a vertical displacement between the vertical guiding part 8 and the vertical guided part 9, in the longitudinal direction of the guiding part 8 and the guided part 9.

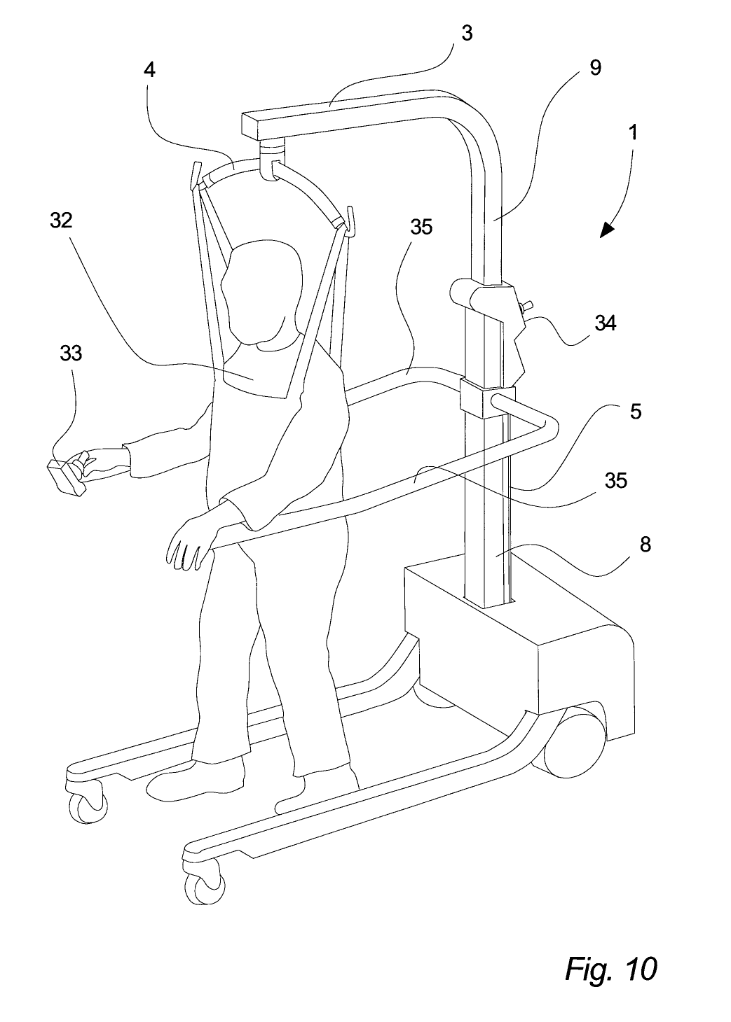

FIG. 10 illustrates an embodiment of the invention where the handling system 1 is supporting a walking person 32.

The supported walking person 32 can control the handling system 1, and has the possibility of driving the handling system in any direction, while being supported by the handling system 1. The handling system 1 can comprise the opportunity of mounting supporting rods 35. The supported walking person 32 can use these supporting rods 35 as arm supports.

The person 32 is controlling the handling system 1 by means of control means placed on at least one control panel 33.

By the term “control panel” is to be understood a panel with control means for controlling at least one control function of the handling system 1.

By the term “control function” is to be understood any function of the handling system 1 controllable by an operator of the handling system 1. A control function could be vertical adjusting of the vertical guided part 9, vertical adjusting of the support part 4, driving the handling system 1 in one or more directions, or the like.

In an embodiment of the invention the supported walking person 32 can control a plurality of control functions for controlling the handling system 1, by means of control means placed on at least one control panel 33.

In an embodiment of the invention the supported walking person 32 can control how much of the persons 32 self-weight the handling system 1 should carry.

In an embodiment of the invention the handling system is controllable by means of a control panel 34 which is placed at the upper part of the vertical guiding part 8, but could also be placed at the cover part 31, on a rod designed for the purpose of comprising control panels or control means, or the like. The control panel 34 could comprise a plurality of control means comprising any relevant control function for controlling the handling system.

In an embodiment of the invention the handling system 1 is controllable by means of an external control panel (not shown in the drawings). The external control panel could be wireless communicating with the handling system 1, as well as connected to the handling system 1 by a cord extending from the handling system 1. The external control panel could comprise control means for controlling a plurality of control functions for controlling the handling system 1.

In an embodiment of the invention, the control means placed on at least one control panel, e.g. the control panel 33 or 34 or the external control panel comprises at least one joystick, touch screen, button or the like. If a control panel comprises a touch screen, the touch screen could also comprise different relevant informations regarding the handling system.

In an embodiment of the invention the handling system 1 comprises at least one display for indication of battery status, time left to recharging of the handling system 1, data comprising the load on the lifting arm 3, the weight carried by the lifting arm 3, or the like.

In an embodiment of the invention the handling system 1 comprises a plurality of control panels comprising control means for controlling the handling system. The control panels could comprise various control means for controlling the handling system.

It will be understood that the invention is not limited to the particular examples described above but may be designed in a multitude of varieties within the scope of the invention, as specified in the claims.

Especially, the actuator for vertical adjustment of the lifting arm and the vertical adjustment guides may be positioned in other places or comprise other elements than the suggested, or be implemented in various ways.

1.-14. (canceled)

15. A handling system for lifting or moving a person from a first position to another, said system comprising
a bottom part comprising a substantially vertical guiding part,
a guided part being guided by said vertical guiding part allowing a lifting arm to be at least vertically adjustable,
a support part for fixating and supporting said person during the lifting or moving, and
a support connection connected to a drive for winding or unwinding said support connection and said support part during the lifting or moving,
wherein said at least vertically adjustable lifting arm is actuated by an actuator during said at least vertical adjusting of the lifting arm.

16. A handling system according to claim 15, wherein the lifting arm is being maintained in a fixed position by the actuator, when not being vertically adjusted.

17. A handling system according to claim 15, wherein said actuator comprises at least one electrical motor and at least one spindle with a thread.

18. A handling system according to claim 17, wherein the electrical motor comprises a locking mechanism which is activated when the spindle is not rotated by the electrical motor.

19. A handling system according to claim 15 , wherein said actuator comprises a motor driven belt, a hydraulic actuator, a pneumatic actuator or a linear actuator including a chain.

20. A handling system according to claim 15, wherein the vertical guided part is guided by at least two vertical adjustment guides positioned opposite each other in relation to said guided part.

21. A handling system according to any one of claim 15, wherein the handling system comprises at least one integrated or external control panel controllable by an operator for at least controlling the actuator.

22. A handling system according to claim 21, wherein said at least one control panel is positioned on the handling system on a supporting rod for supporting the person being handled by the handling system, and is connected via a wired or wireless connection to the handling system.

23. A handling system according to claim 15, wherein the support part is a walking harness for the person.

24. A handling system according to claim 15, wherein the system comprises a number of support connection guides for guiding the support connection inside the different parts of the system.

25. A handling system according to claim 24, wherein the support connection guides are arranged inside the lifting arm, inside the bottom part and/or said vertical guiding part.

26. A handling system for supporting a person in an upright position, said system comprising:
a bottom part comprising a substantially vertical guiding part,
a guided part being guided by said vertical guiding part allowing a lifting arm to be at least vertically adjustable,
a support part for supporting said person in the upright position,
a support connection connected to a drive for winding or unwinding said support connection and said support part during lifting or moving,
at least one control panel comprising control means for controlling at least one control function of the handling system,
wherein said at least one control panel is positioned within reach of the person when supported in the handling system.

27. A handling system according to claim 26, wherein said at least one control panel is positioned on the handling system on a supporting rod for supporting the person being handled by the handling system and is connected via a wired or wireless connection to the handling system.

28. A method for lifting or moving a person from a first position to another by a handling system, said method comprising the steps of
positioning a person in a support part with a support connection,
activating a drive for winding and unwinding the support connection, hereby vertically adjusting the support part, and
vertically adjusting said lifting arm of the handling system by means of an actuator, said actuator allowing the lifting arm to be vertically adjustable.

29. A method according to claim 28, whereby the handling system is fitted to support a person in an upright position by means of the support part, where said supported person is able to reach and control at least one control panel with control means for controlling at least one control function of the handling system.

30. A method according to claim 29, wherein said upright position a walking situation of the supported person.

31. A method according to of claim 28 for allowing a patient to stand upright and walk when suspended in a support part of the handling system.
